(19) United States
(12) Patent Application Publication
(10) Pub. No.: US 2014/0168260 A1
(43) Pub. Date: Jun. 19, 2014

(54) WAVEGUIDE SPACERS WITHIN AN NED DEVICE

(71) Applicants: Paul M. O'Brien, Sammamish, WA (US); Ian A. Nguyen, Bellevue, WA (US)

(72) Inventors: Paul M. O'Brien, Sammamish, WA (US); Ian A. Nguyen, Bellevue, WA (US)

(21) Appl. No.: 13/713,508

(22) Filed: Dec. 13, 2012

(51) Int. Cl. G02B 6/00; G09G 5/377

(52) U.S. Cl. CPC G02B 6/00; G09G 5/377
USPC 345/633; 385/134

(57) ABSTRACT

A system is disclosed for maintaining the spacing between waveguides in an optical element of a near eye display. Spacing is maintained with spacer elements mounted between adjacent waveguides in the optical element.

### BACKGROUND

A see-through, near-to-eye display (NED) unit may be used to display virtual imagery mixed with real-world objects in a physical environment. Such NED units include a light engine for generating an image, and an optical element which is partly transmissive and partly reflective. The optical element is transmissive to allow light from the outside world to reach the eye of an observer, and partly reflective to allow light from the light engine to reach the eye of the observer. The optical element may include diffractive optical elements (DOEs) or holograms within a planar waveguide to diffract the imagery from the microdisplay to the eye of the user.

### SUMMARY

Embodiments of the present technology relate to a system for maintaining the spacing between waveguides in an optical element. NED units may include a stack of multiple waveguides, with each waveguide assigned to a wavelength component. The waveguides may be thin, and spaced from each other by a small air gap so that light rays entering a waveguide may undergo total internal reflection (TIR) without prematurely exiting the waveguide. A problem with such conventional optical elements is that some sensitive DOEs on the surface of the waveguides are susceptible to damage caused by minor mechanical perturbations (vibrations, drops, touches, etc.) that force the waveguides to flex and bump into each other.

In embodiments, a spacing between waveguides in an optical element may be maintained with spacer elements mounted between adjacent waveguides in the optical element. The number of spacer elements between adjacent waveguides may vary, but may be between four and six in examples of the present technology. Where there are more than two waveguide layers, the spacer elements between different waveguide layers may align with each other. The spacer elements maintain the spacing between the waveguides in the optical element to prevent damage to the waveguides due to mechanical perturbations.

In an example, the present technology relates to an optical element for transmitting light from a light source to an eye box in a head mounted display device, comprising: first and second waveguides spaced from each other by a gap, the first and second waveguides receiving light from the light source and reflecting received light to the eye box; and one or more spacer elements positioned within the gap for maintaining a spacing between the first and second waveguides.

In another example, the present technology relates to an optical element for transmitting light from a light source to an eye box in a head mounted display device, comprising: first, second and third waveguides, the first and second waveguides separated from each other by a first gap, the second and third waveguides separated from each other by a second gap, the first, second and third waveguides receiving light from the light source and reflecting received light to the eye box; a first set of one or more spacer elements positioned within the first gap for maintaining a spacing between the first and second waveguides; and a second set of one or more spacer elements positioned within the second gap for maintaining a spacing between the second and third waveguides.

In a further example, the present technology relates to a system for presenting virtual objects in a mixed reality environment, the system comprising: a head mounted display including an optical element allowing images to be displayed from a light source to an eye box and allowing light from real world objects to reach the eye box, the optical element comprising: first and second waveguides spaced from each other by a gap, the first and second waveguides receiving light from the light source and reflecting received light to the eye box, and one or more spacer elements positioned within the gap for maintaining a spacing between the first and second waveguides; and a processor for generating virtual images for display to the eye box from the light source, the one or more spacer elements not interfering with light reaching the eye box from real world objects.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an illustration of example components of one embodiment of a system for presenting a virtual environment to one or more users.

FIG. 2 is a perspective view of one embodiment of a head-worn NED unit.

FIG. 3 is a side view of a portion of one embodiment of a head-worn NED unit.

FIG. 4 is a side view of a portion of one embodiment of a head-worn NED unit including an optical element having a plurality of waveguides and spacer elements.

FIG. 5 is an edge view of an optical element from an NED unit including a waveguide having diffraction gratings.

FIGS. 6 through 11 are alternative embodiments of an optical element having waveguides and spacer elements.

FIG. 12 is side view of an optical element including waveguides and spacer elements.

### DETAILED DESCRIPTION

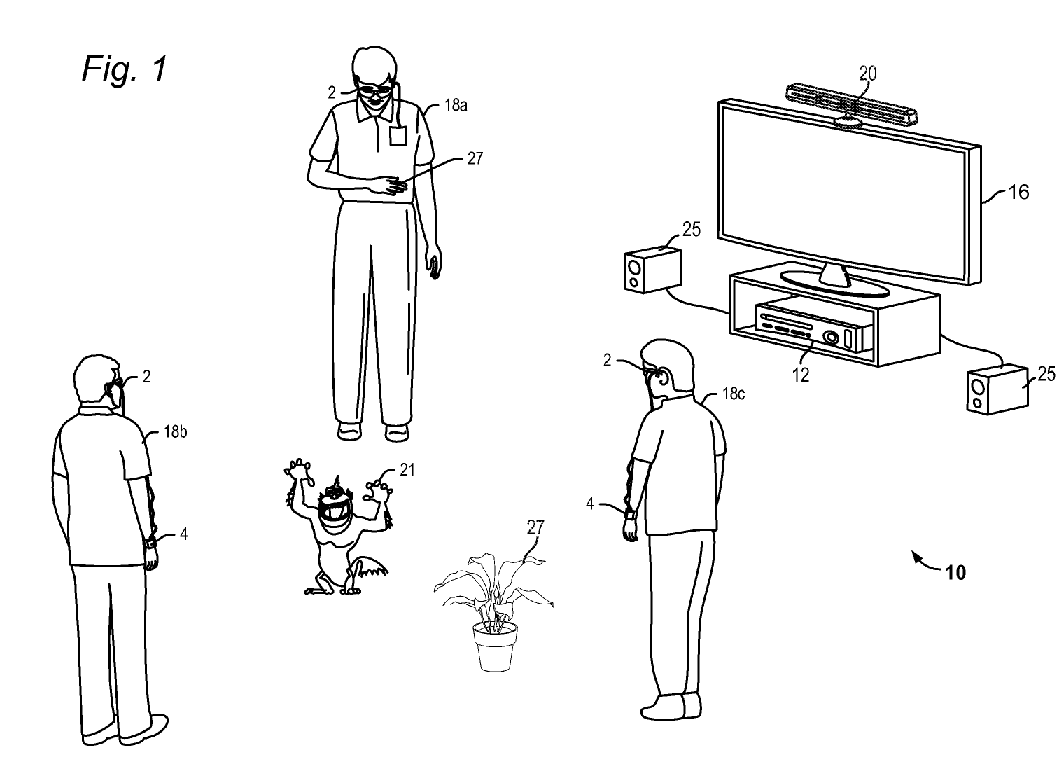

Embodiments of the present technology will now be described with reference to FIGS. 1-12, which in general relate to an optical element in an NED unit including spacing elements for maintaining a spacing between a stack of two or more waveguides within the optical element. In embodiments explained below, the NED unit may be a head-worn display unit used in a mixed reality system. However, it is understood that embodiments of the NED unit and imaging optics contained therein may be used in a variety of other optical applications, for example in optical couplers and other light modulator devices. The figures are provided for an understanding of the present technology, and may not be drawn to scale.

FIG. 1 illustrates an example of NED units 2 as head-worn displays used in a mixed reality system 10. The NED units may be worn as glasses including lenses which are to a degree transparent so that a user can look through the display element at real-world objects 27 within the user's field of view (FOV). The NED unit 2 also provides the ability to project virtual images 21 into the FOV of the user such that the virtual images may also appear alongside the real-world objects. Although not critical to the present technology, the mixed reality system may automatically track where the user is looking so that the system can determine where to insert the virtual image in the FOV of the user. Once the system knows where to project the virtual image, the image is projected using the display element.

FIG. 1 shows a number of users 18a, 18b and 18c each wearing a head-worn NED unit 2. Head-worn NED unit 2, which in one embodiment is in the shape of glasses, is worn on the head of a user so that the user can see through a display and thereby have an actual direct view of the space in front of the user. More details of the head-worn NED unit 2 are provided below.

The NED unit 2 may provide signals to and receive signals from a processing unit 4 and a hub computing device 12. The NED unit 2, processing unit 4 and hub computing device 12 may cooperate to determine the FOV of each user 18, what virtual imagery should be provided within that FOV and how it should be presented. Hub computing device 12 further includes a capture device 20 for capturing image data from portions of a scene within its FOV. Hub computing device 12 may further be connected to an audiovisual device 16 and speakers 25 that may provide game or application visuals and sound. Details relating to the processing unit 4, hub computing device 12, capture device 20, audiovisual device 16 and speakers 25 are provided for example in United States Patent Publication No. 2012/0105473, entitled, “Low-Latency Fusing of Virtual and Real Content,” published May 3, 2012, which application is hereby incorporated by reference herein in its entirety.

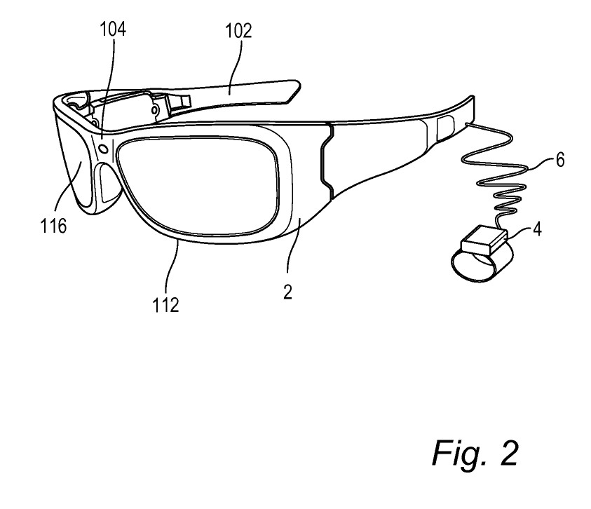

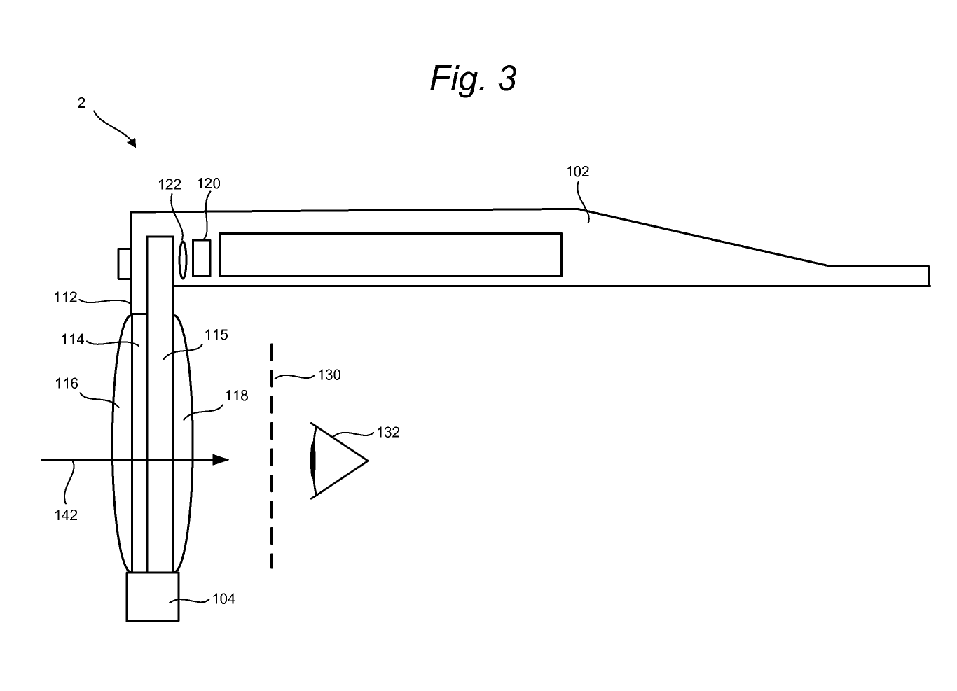

FIGS. 2 and 3 show perspective and side views of the head-worn NED unit 2. FIG. 3 shows the right side of head-worn NED unit 2, including a portion of the device having temple 102 and nose bridge 104. A portion of the frame of head-worn NED unit 2 will surround a display (that includes one or more lenses). The display includes light-guide optical element 115, see-through lens 116 and see-through lens 118 mounted within a frame 112. In one embodiment, light-guide optical element 115 is behind and aligned with see-through lens 116, and see-through lens 118 is behind and aligned with light-guide optical element 115. See-through lenses 116 and 118 are standard lenses used in eye glasses and can be made to any prescription (including no prescription). Light-guide optical element 115 channels artificial light to the eye. More details of light-guide optical element 115 are provided below.

Mounted to or inside temple 102 is an image source, which (in embodiments) includes a light engine such as a microdisplay 120 for projecting a virtual image and lens 122 for directing images from microdisplay 120 into light-guide optical element 115. In one embodiment, lens 122 is a collimating lens. Microdisplay 120 projects an image through lens 122.

There are different image generation technologies that can be used to implement microdisplay 120. For example, microdisplay 120 can be implemented in using a transmissive projection technology where the light source is modulated by optically active material, backlit with white light. These technologies are usually implemented using LCD type displays with powerful backlights and high optical energy densities. Microdisplay 120 can also be implemented using a reflective technology for which external light is reflected and modulated by an optically active material. The illumination is forward lit by either a white source or RGB source, depending on the technology. Digital light processing (DLP), liquid crystal on silicon (LCOS) and Mirasol® display technology from Qualcomm, Inc. are examples of reflective technologies which are efficient as most energy is reflected away from the modulated structure and may be used in the present system. Additionally, microdisplay 120 can be implemented using an emissive technology where light is generated by the display. For example, a PicoP™ display engine from Microvision, Inc. emits a laser signal with a micro mirror steering either onto a tiny screen that acts as a transmissive element or beamed directly into the eye (e.g., laser).

Light-guide optical element (also called just optical element) 115 may transmit light from microdisplay 120 to an eye box 130. The eye box 130 is a two-dimensional area, positioned in front of an eye 132 of a user wearing head-worn NED unit 2, through which light passes upon leaving the optical element 115. Optical element 115 also allows light from in front of the head-worn NED unit 2 to be transmitted through light-guide optical element 115 to eye box 130, as depicted by arrow 142. This allows the user to have an actual direct view of the space in front of head-worn NED unit 2 in addition to receiving a virtual image from microdisplay 120.

FIG. 3 shows half of the head-worn NED unit 2. A full head-worn display device may include another optical element 115, another microdisplay 120 and another lens 122. Where the head-worn NED unit 2 has two optical elements 115, each eye can have its own microdisplay 120 that can display the same image in both eyes or different images in the two eyes. In another embodiment, there can be one optical element 115 which reflects light into both eyes from a single microdisplay 120.

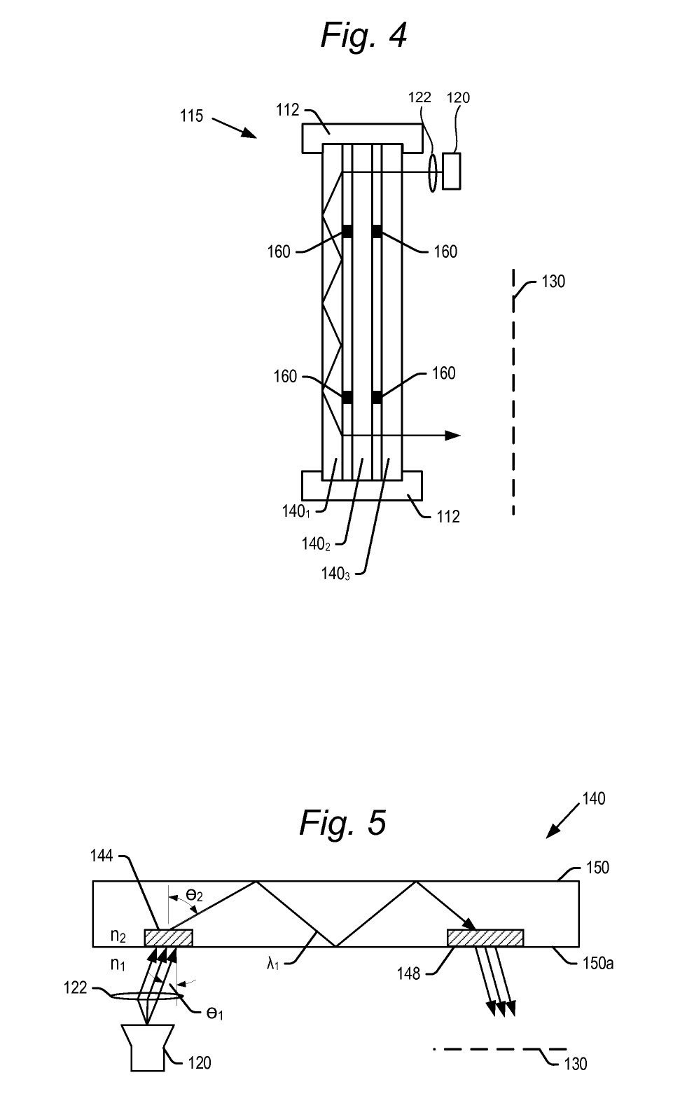

Further details of light-guide optical element 115 will now be explained with reference to FIGS. 4-12. In general, optical element 115 includes two or more waveguides 140 stacked one on top of another to form an optical train. One such optical train is shown in FIG. 4. In the example shown, the optical element 115 includes three waveguides 140₁, 140₂ and 140₃. However, different examples may include two waveguides 140, or more than three waveguides 140. In embodiments, each waveguide 140 may be tuned, or matched, to a different wavelength band. Thus, as light is projected from microdisplay 120 into the optical element, light of a given wavelength will couple into a waveguide and be reflected back to the eye box 130, while light of other wavelengths will pass through that waveguide.

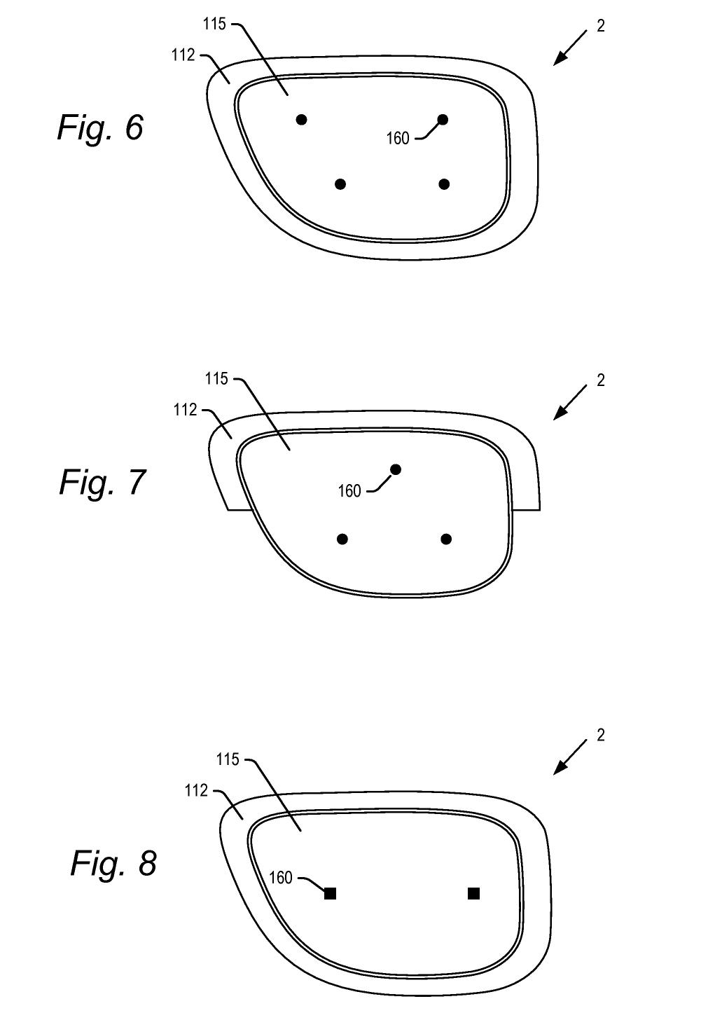

Referring to FIG. 5, a waveguide 140 may be formed of a thin planar sheet of glass, though it may be formed of plastic or other materials in further embodiments including plastic and silica for example. Waveguide 140 may have two or more diffraction gratings, including an input diffraction grating 144 which couples light rays into the waveguide 140, and an exit diffraction grating 148 which diffracts light rays out of the waveguide 140. The gratings 144, 148 are shown as transmissive gratings affixed to, or within, a lower surface 150a of substrate 150. Reflective gratings affixed to the opposite surface of substrate 150 may be used in further embodiments.

FIG. 5 shows the total internal reflection of a wavelength band, λ₁, coupled into and out of waveguide 140. The illustration of FIG. 5 is a simplified view of a single wavelength band in a system where the second and higher diffraction orders are not present. Wavelength band λ₁ from microdisplay 120 is collimated through the lens 122 and is coupled into the substrate 150 by input diffraction grating 144 at an incident angle θ₁. The input diffraction grating 144 redirects the wavelength band through an angle of diffraction θ₂. The refractive index n2, angle of incidence θ₁, and angle of diffraction θ₂ are provided so that the wavelength band λ₁ undergoes total internal reflection within the substrate 150. The wavelength band λ₁ reflects off the surfaces of substrate 150 until it strikes exit diffraction grating 148, whereupon the wavelength band λ₁ is diffracted out of the substrate 150 toward eye box 130.

Referring now to FIGS. 4 and 6-11, the waveguides 140 may be supported and secured in position by the frame 112, which supports each waveguide 140 separated by a small air gap. While referred to as an air gap herein, it is conceivable that the gap between adjacent wave guides be a sealed environment containing something other than air. The frame 112, shown schematically in FIGS. 4 and 6-11, may extend completely around an outer periphery of the waveguides 140, or partially around the outer periphery of the waveguides 140. As noted in the Background section, mechanical perturbations such as vibration, shock and other forces may press two or more of the waveguides into contact with each other, thereby possibly damaging the optical components of the waveguides affecting their proper operation and/or function.

In accordance with the present technology, the spacing between waveguides 140 in the optical element 115 may be maintained by one or more spacer elements 160. The spacer elements 160 may be made of glass, silica or plastic, and may be the same material as the waveguides 140, to prevent thermal mismatch. However, the spacer elements 160 may be made of material different than the waveguides 140 in embodiments, such as for example rubber. In a further example, as explained below, the spacer elements 160 may be a polymer such as an epoxy.

Each spacer element may be identical to each other spacer element, though they need not be identical in further embodiments. The spacer elements 160 may be circular, but may be other shapes in further embodiments, including for example elliptical, square, rectangular, triangular, etc. The dimensions of the spacer elements 140 may be small, so as to minimize the obstruction of light passing through the optical element 115. In one example, each spacer element 160 may be 0.5 mm, though they may be larger or smaller than that in further embodiments. The thicknesses of the spacer elements will depend on, and match, the size of the air gap between adjacent waveguides 140. In embodiments, the air gap may be as small as a few microns, and as large as a few hundred microns. The air gap, and the thickness of the spacer elements, may be smaller or larger than that in further examples.

In embodiments, the spacer elements 160 are light-absorbing, such as for example being colored black. This minimizes the amount of stray light scattered by the spacers elements 160 that may be seen by the user of the head mounted display.

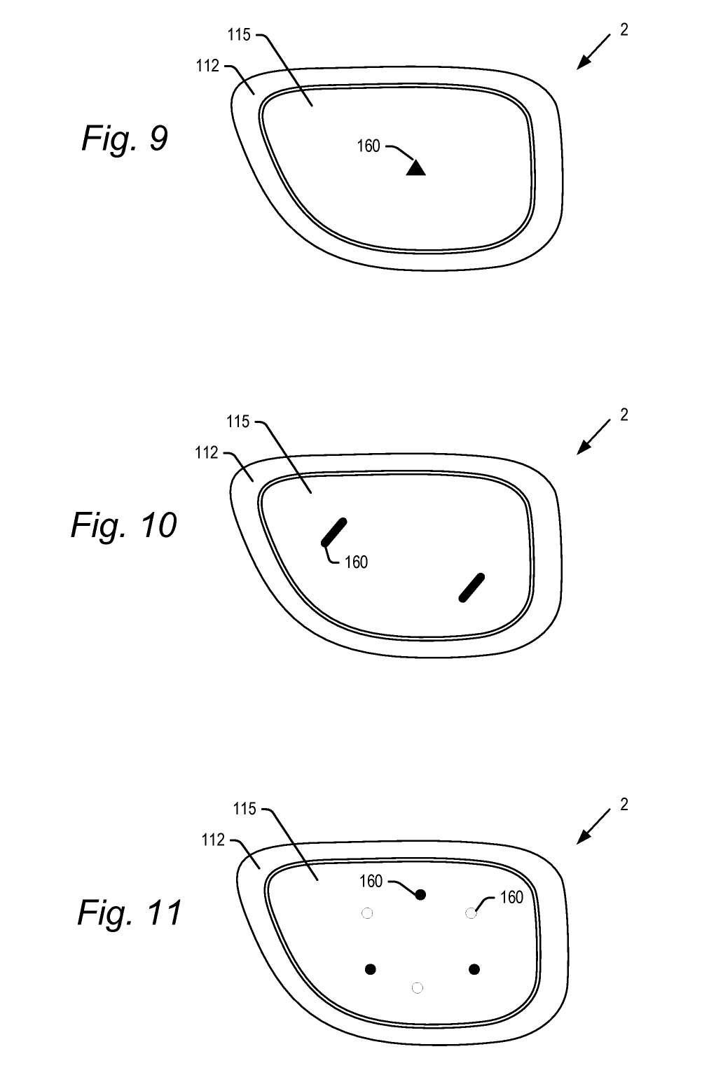

FIGS. 6 through 11 illustrate front views of a portion of a head mounted display 2 including the optical element 115 within the frame 112. The frame 112 may extend around the entire periphery of the optical element 115 as shown for example in FIG. 6, but it need not as indicated above and as shown for example in FIG. 7. Moreover, while the shape of the frame 112 and optical element 115 are that of one side of an eye-glass configuration, the frame 112 and optical element 115 may be other shapes in further examples. As noted below, in embodiments, the shape of the frame 112 may be a factor in the location of spacer elements 160. While a single side of head mounted display 2 is shown in FIGS. 6 through 11, the other side may have an identical configuration of optical element 115 and spacer elements 160. In further embodiments, it is conceivable that the left side optical element 115 and spacer element 160 arrangement would be different than that for the right side.

FIGS. 6 through 9 illustrate optical element 115 with various numbers of spacer elements 160, ranging between four (FIG. 6) to one (FIG. 9). Only some of the spacer elements are numbered in the figures. It is possible that there be more than four spacer elements 160 between two waveguides 140 in further embodiments. As noted above, the shape of the spacer elements may also vary. For example, FIG. 6 shows the spacer elements as being rounded, for example as a circle or an ellipse. FIG. 8 shows the spacer elements as being a quadrangle, such as a square or rectangle (with sharp or rounded corners). FIG. 9 illustrates an example where spacer element 160 is triangular. The spacer element may further be elongated, such as for example shown in FIG. 10. It is understood any of the above-described shapes for spacer elements 160 can be used in any of the embodiments of FIGS. 6 through 11.

The arrangement of the spacer elements 160 in FIGS. 6 through 11 is by way of example only, and it is understood that the spacer elements 160 may be places anywhere within the air gap between adjacent waveguides in embodiments. One factor which may be used in positioning the spacer elements is to space them evenly inward of the frame 112 and evenly spaced from each other. That is, the frame 112 provides support for the waveguides, so positioning the spacer elements 160 near to the frame may not be optimal. It is, however, conceivable to place the spacer elements 160 near to the frame 112 in further embodiments.

It may also be desirable to space the spacer elements apart from each other to provide even support for the waveguides across the surface of respective waveguides. However, the spacer elements 160 may be positioned closely to each other in further embodiments. Further it may not be desired to position the spacer elements at a position that results in the spacer elements being centered in front of a user's eye (centered over the eye box 130), though again, it is conceivable that spacer elements would be so centered (as shown in FIG. 9).

In embodiments, the spacer elements 160 would not be placed over the DOEs (input, fold, or output) of the respective waveguides 140.

Where there are three or more waveguides within the optical element 115, the air gap between each adjacent pairs of waveguides may include spacer elements 160. These spacer elements 160 in such an optical element 115 may align with each other in the respective layers so as to minimize the number of spacer elements that block light coming into the optical element 115. However, as shown for example in FIG. 11, the spacer elements 160 in respective layers need not align with each other. In FIG. 11, the spacer elements 160 in a first air gap between first and second waveguides are shown as filled, solid circles, while the spacer elements 160 in a second air gap between second and third waveguides are shown as dashed-line circles. If the optical element 115 included more waveguides, the spacer elements 160 in the air gap(s) of these additional waveguides may align with the spacer elements 160 between the first and second waveguides, the second and third wave guides, or neither.

The spacer elements 160 may be affixed within the air gap at the desired positions when the optical element is assembled. In embodiments, a known adhesive material may be used on a top and/or bottom surface of a spacer element 160 to affix the spacer element to one or both waveguides 140 with which the spacer element lies in contact. As one example, the spacer element(s) 160 may be affixed to a first waveguide 140, and then the waveguide 140 affixed together with an adjacent waveguide in the optical element, with the spacer element(s) positioned in the air gap between the elements.

In further embodiments, the spacer element itself may be an adhesive resin such as for example an epoxy. In such embodiments, the epoxy may be provided as a b-stage adhesive in the air gap at the desired position between adjacent waveguides. Once positioned, the epoxy may be cured to a c-stage where it is solid and maintains the spacing between adjacent waveguides. When applied in the b-stage, the epoxy may be applied at the desired thickness of the air gap. It is understood that other curable adhesives may be used as the spacer element 160, so long as they may be applied at a thickness to match the air gap, and thereafter transformed into a solid to maintain the air gap thickness. A liquid adhesive may work for this purpose, with the initial thickness matching the air gap thickness as a result of surface adhesion of the liquid adhesive on the adjacent surfaces of the waveguides on either side of the air gap.

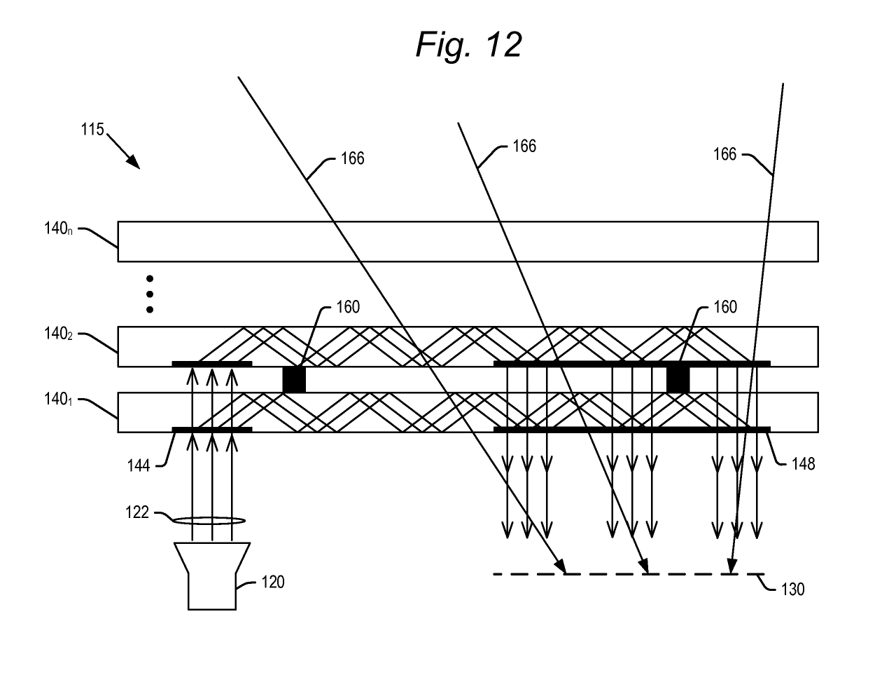

FIG. 12 illustrates an optical element 115 including waveguides 140₁, 140₂, . . . , 140ₙ. Each pair of adjacent waveguides 140 may be separated by an air gap including one or more spacer elements 160 (only shown for the first pair of waveguides 140₁ and 140₂. The spacer elements maintain the spacing between the waveguides while allowing the light to couple into and decouple from the waveguides. Also shown are light rays 166 illustrating light from real world objects passing through the optical element 115, minimally affected by the spacer elements 160.

The spacer elements 160 in accordance with any of the above-described embodiments allows the narrow air gaps between waveguides 140 in an optical element 115 to be maintained to provide protection against contacts or crashes of waveguides against each other during mechanical perturbations. In embodiments, the spacer elements 160 are small and light absorbing so there will be minimal loss of light propagation in and through the waveguides 140. This allows for the least amount of interference with the functions of the waveguides, including pupil expansions, diffraction, TIR, light propagation, and see-through to real world objects. Additionally, as the spacer elements 160 are near to the eye, the see-through quality to real world objects is minimally affected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

We claim:

1. An optical element for transmitting light from a light source to an eye box in a head mounted display device, comprising:
first and second waveguides spaced from each other by a gap, the first and second waveguides receiving light from the light source and reflecting received light to the eye box;
one or more spacer elements positioned within the gap for maintaining a spacing between the first and second waveguides.

2. The optical element recited in claim 1, wherein the one or more spacer elements are light absorbing.

3. The optical element recited in claim 1, wherein the one or more spacer elements are of a material and at one or more positions that do not affect pupil expansion of light through the optical element.

4. The optical element recited in claim 1, wherein the one or more spacer elements are of a material and at one or more positions that do not affect diffraction of light in the first and second waveguides.

5. The optical element recited in claim 1, wherein the one or more spacer elements are of a material and at one or more positions that do not affect total internal reflection of light in the first and second waveguides.

6. The optical element recited in claim 1, wherein the one or more spacer elements are of a material and at one or more positions that do not affect propagation of light in the first and second waveguides.

7. The optical element recited in claim 1, further comprising a frame around at least a portion of an outer periphery of the first and second waveguides for supporting the first and second waveguides at outer edges of the first and second waveguides.

8. The optical element recited in claim 7, wherein the spacer elements comprise two or more spacer elements evenly distributed across adjacent surfaces of the first and second waveguides.

9. The optical element recited in claim 1, wherein the one or more spacer elements are of a material and at one or more positions that minimally affect see-through to real world objects.

10. The optical element recited in claim 1, wherein the one or more spacer elements comprise one of a single spacer element, two spacer elements, three spacer elements and four spacer elements.

11. The optical element recited in claim 1, wherein the one or more spacer elements are one of glass, silica and plastic.

12. The optical element recited in claim 1, wherein the one or more spacer elements are an epoxy resin.

13. An optical element for transmitting light from a light source to an eye box in a head mounted display device, comprising:
first, second and third waveguides, the first and second waveguides separated from each other by a first gap, the second and third waveguides separated from each other by a second gap, the first, second and third waveguides receiving light from the light source and reflecting received light to the eye box;
a first set of one or more spacer elements positioned within the first gap for maintaining a spacing between the first and second waveguides; and
a second set of one or more spacer elements positioned within the second gap for maintaining a spacing between the second and third waveguides.

14. The optical element recited in claim 13, wherein the one or more spacer elements of the first set align over the one or more spacer elements of the second set.

15. The optical element recited in claim 13, wherein the one or more spacer elements of the first set are not aligned over the one or more spacer elements of the second set.

16. The optical element recited in claim 13, wherein the one or more spacer elements of the first set and the one or more spacer elements of the second set are not aligned over the eye box.

17. A system for presenting virtual objects in a mixed reality environment, the system comprising:
a head mounted display including an optical element allowing images to be displayed from a light source to an eye box and allowing light from real world objects to reach the eye box, the optical element comprising:
first and second waveguides spaced from each other by a gap, the first and second waveguides receiving light from the light source and reflecting received light to the eye box, and
one or more spacer elements positioned within the gap for maintaining a spacing between the first and second waveguides; and
a processor for generating virtual images for displayed to the eye box from the light source, the one or more spacer elements not interfering with light reaching the eye box from real world objects.

18. The optical element recited in claim 13, wherein the one or more spacer elements are positioned in the gap to minimize interference of the light from the real world objects reaching the eye box.

19. The optical element recited in claim 13, wherein the one or more spacer elements are positioned to evenly support the spacing of the first and second waveguides.

20. The optical element recited in claim 13, wherein the one or more spacer elements are positioned in the gap to minimize interference on pupil expansions, light diffraction, total internal reflection, and light propagation.
